(19) United States
(12) Patent Application Publication
(10) Pub. No.: US 2009/0123251 A1
(43) Pub. Date: May 14, 2009

(54) Powder-actuated mechanical lock concrete anchor

(75) Inventor: William Dubon, Bloomingdale, IL (US)

Correspondence Address: Steven W. Weinrieb;LAW OFFICES OF STEVEN W. WEINRIEB, 8717 Cold Spring Road, Potomac, MD, 20854, US

(73) Assignee: ILLINOIS TOOL WORKS INC.

(21) Appl. No.: 12/213,847

(22) Filed: Jun. 25, 2008

Related U.S. Application Data
(60) Provisional application No. 60/996,317, filed on Nov. 9, 2007.

(51) Int. Cl. F16B 13/04

(52) U.S. Cl. 411/20

(57) ABSTRACT

A powder-actuated mechanical lock concrete anchor, wherein the lower end portion of the concrete anchor is adapted to be disposed within the lower end portion of a blind bore drilled within a concrete substrate, and wherein a powder-actuated mechanical locking device is located within the lower end portion of the concrete anchor such that when the powder-actuated mechanism of the powder-actuated mechanical locking device is in fact actuated, either electrically or mechanically, the mechanical locking device will effectively be expanded radially outwardly so as to be lockingly engaged within lower side wall portions of the concrete substrate so as to in fact mechanically lock the concrete anchor within the blind bore drilled within the concrete substrate.

### CROSS-REFERENCE TO RELATED PATENT APPLICATION

This patent application is related to, based upon, and effectively a utility patent application conversion from U.S. Provisional Patent Application Ser. No. 60/996,317, which was filed on Nov. 9, 2007, the filing date benefits of which are hereby claimed.

### FIELD OF THE INVENTION

The present invention relates generally to concrete anchors, and more particularly to a new and improved powder-actuated mechanical lock concrete anchor, wherein the lower end portion of the concrete anchor is adapted to be disposed within the lower or inner end portion of a blind bore drilled within, for example, a concrete substrate, and wherein a powder-actuated mechanical locking device is located within the lower end portion of the concrete anchor such that when the powder-actuated mechanism of the powder-actuated mechanical locking device is in fact actuated, either electrically or mechanically, the mechanical locking device will effectively be expanded radially outwardly so as to be lockingly engaged within lower side wall portions of the concrete substrate, which at least partially define the lower end portion of the blind bore drilled within the concrete substrate, so as to in fact mechanically lock the concrete anchor within the blind bore drilled within the concrete substrate. As is conventional with respect to concrete anchors in general, the new and improved concrete anchor of the present invention is adapted to be utilized to secure or fix various different objects, articles, mounting brackets, or the like, onto different regions of the concrete substrate as may be required.

### BACKGROUND OF THE INVENTION

In connection with the securing or affixing of anchors within different substrates, such as, for example, a concrete substrate or the like, in order to, in turn, secure, fix, or mount an article, object, mounting bracket, or the like, onto the concrete substrate, various types of conventional anchors, and methods for installing the same, are of course well known in the art and industry. For example, a first exemplary type of a conventional, well-known anchor, and the method of installing the same within, for example, a concrete substrate or the like, is disclosed within FIGS. 1-4 and is generally indicated by the reference 100. The first exemplary type of anchor is adapted to be secured within the concrete substrate as a result of a predetermined amount of friction effectively developed between the anchor and interior side wall portions of the concrete substrate which partially define a blind bore into which the anchor is to be placed. More particularly, the concrete substrate is disclosed at 102, and a blind bore 104 is initially drilled within the concrete substrate 102 by means of a suitable drill bit 106 which is rotatably driven by means of a suitable power tool 108. Subsequently, as illustrated within FIG. 2, the interior of the blind bore 104 is cleaned of debris 110, developed during the bore drilling process, by means of a suitable cleaning tool 112 such that the debris will not adversely interfere with the requisite friction to be developed between the anchor and the interior side wall portions of the concrete substrate, which partially define the blind bore into which the anchor is to be placed, when in fact the anchor is inserted into the blind bore 104.

After the aforenoted cleaning operation has been completed, the article to be affixed to the concrete structure or substrate 102, such as, for example, a mounting bracket or the like 114 having a hole 116 preformed therein so as to permit an anchor to be inserted therethrough, is in fact disposed upon the concrete structure or substrate 102 and an anchor 118 is inserted through the hole 116 of the mounting bracket or the like 114 such that substantially the entire axial length or extent of the anchor 118 is now disposed within the blind bore 104. The anchor 118 is, for example, of the type which comprises an external sleeve member which is externally threaded as at 120 so as to frictionally engage the interior side wall portions of the concrete structure or substrate which partially define the blind bore 104 into which the anchor 118 is now disposed, and an internal rod member 122, the upper end portion of which is externally threaded as at 124 so as to be capable of having an internally threaded torquing nut 126 threadedly engaged thereon. Accordingly, when the torquing nut 126 is in fact continuously threaded onto the upwardly projecting externally threaded end portion 124 of the internal rod member 122 of the anchor 118 by means of a suitable torquing tool 128, and torqued to a predetermined degree, the lower end portion of the internal rod member 122 will have caused the lower end portion of the external sleeve member of the anchor 118 to be expanded radially outwardly so as to in fact frictionally engage the interior side wall portions of the concrete structure or substrate 102, which partially define the blind bore 104 into which the anchor 118 is now disposed, so as to in fact fixedly secure the anchor 118 within the concrete structure or substrate 102.

While the aforenoted frictional type anchors are of course generally quite satisfactory in their operations or onsite functions or service, one of the operational drawbacks characteristic of frictional type anchors is that, as has been noted, the blind bores, pre-drilled within the concrete structure or substrate, need to be cleaned prior to the insertion of the anchors into the concrete structure or substrate. It can therefore be readily appreciated that if a particular building site or project requires, for example, the installation of hundreds or thousands of anchors, the cleaning step of the installation process is quite time-consuming and costly. Accordingly, another type of well-known conventional type of concrete anchor comprises a mechanical lock type anchor wherein, in lieu of the anchor effectively being secured within the concrete substrate by means of friction developed between the anchor and the interior side wall portions of the concrete structure or substrate which partially define the blind bore into which the anchor is disposed, the anchor actually comprises radially outwardly extending or projecting structure which mechanically engages the interior side wall portions of the concrete structure or substrate which partially define the blind bore into which the anchor is disposed. More particularly, for example, and with reference being made to FIGS. 5-13, a particular embodiment of conventional prior art mechanical lock type anchor, adapted to be fixedly secured or embedded within, for example, a concrete structure or substrate, as well as an undercutting tool for facilitating the installation of the conventional prior art mechanical lock type anchor within the concrete structure or substrate, is disclosed and is generally indicated by the reference character 200. It is to be understand that, for the purposes of this disclosure and description, those component parts of the anchor system disclosed within FIGS. 5-13, which effectively correspond to the components parts of the anchor system disclosed within FIGS. 1-4, will be designated by corresponding reference characters, where possible, except that they will be within the 200 series.

More particularly, as was the case with the anchor system 100 as disclosed within FIGS. 1-4, a concrete structure or substrate 202 has a blind bore 204 drilled therewithin to a predetermined depth. Prior to the installation of the conventional prior art mechanical lock type anchor within the pre-drilled blind bore 204, it is noted that no cleaning of the blind bore 204 is required. Accordingly, in order to effectively prepare the pre-drilled blind bore for receiving the conventional prior art mechanical lock type anchor therewithin, an undercutting tool 206 is inserted downwardly into the pre-drilled blind bore 204. The undercutting tool 206 is seen to comprise an outer tubular member 208 which has a shoulder portion 210 fixedly disposed upon an upper end portion thereof such that when the outer tubular member 208 is inserted downwardly into the pre-drilled blind bore 204, the shoulder portion 210 of the undercutting tool 206 will engage the upper surface portion 212 of the concrete structure or substrate 202, as illustrated within FIG. 6, so as to properly position the lower end portion of the undercutting tool 206 within the lower end portion of the pre-drilled blind bore 204. It is also seen that the undercutting tool 206 comprises a head portion 214 and a neck portion 216 fixedly interconnecting the head portion 214 to the shoulder portion 210. An inner rod member, having an enlarged upper end portion 218, is reciprocally movable within the outer tubular member 208 and is normally biased to a raised position, as illustrated within FIG. 6, by means of, for example, a coil spring member 220 which extends between the lower end of the enlarged upper end portion 218 of the inner rod member and down into the head and neck portions 214,216 of the undercutting tool 206.

Still further, it is seen that diametrically opposite regions of the neck portion 216 of the undercutting tool 206 are respectively provided with elongated, vertically oriented slots 222, only one of which is visible, and that the inner rod member is correspondingly provided with a pair of diametrically opposed, radially outwardly projecting guide pins 224, only one of which is visible, which are respectively movably disposed within the slots 222. The lower end portion of the outer tubular member 208 is also provided with a pair of diametrically opposed slits or slots, not shown, at a predetermined axial distance above the lower end portion of the outer tubular member 208, and the lower end portion of the inner rod member is provided with a pair of diametrically opposite cutting blades 226 which are radially movable in a radially outwardly expansible, and a radially inwardly contractible, mode of operation.

Accordingly, as can readily be appreciated from a comparison of FIGS. 6 and 7, when the inner rod member is moved vertically downwardly within the outer tubular member 208 of the undercutting tool 206 against the biasing force of the coil spring member 220, as can be seen or appreciated by the engagement of the enlarged upper end portion 218 of the inner rod member with the head portion 214 of the undercutting tool 206, as well as by the downward movements of the guide pins 224 within the slots 222, linkage or similar means, not shown, operatively connected to the radially movable cutting blades 226, will cause the radially movable cutting blades 226 to project outwardly through the slits or slots, not shown, of the outer tubular member 208 so as to engage interior side wall portions of the concrete substrate or structure 202 which partially define the pre-drilled blind bore 204. Accordingly, still further, when the undercutting tool 206 is then angularly rotated by any suitable means, not shown, the cutting blades 226 will effectively cut and define an annular undercut or counterbored region within the side wall portions of the concrete structure or substrate 202 at a predetermined distance above the bottom of the pre-drilled blind bore 204 as can best be seen in FIG. 8 as at 228. Upon completion of the aforenoted undercutting or counterboring operation, the enlarged upper end portion 218 of the inner rod member will effectively be released so as to effectively return the inner rod member of the undercutting tool 206 to its original position as illustrated within FIG. 6. Accordingly, the blade members 226 are correspondingly moved back or returned to their radially contracted position and the undercutting tool 206 is now removed from the undercut or counterbored pre-drilled blind bore 204 as illustrated within FIG. 8 such that the conventional prior art mechanical lock type anchor is now ready to be installed within the undercut or counterbored pre-drilled blind bore 204 defined within the concrete structure or substrate 202. More particularly, the conventional prior art mechanical lock type anchor 230, as illustrated within FIGS. 9-13, is seen to comprise an external sleeve member 232 which is provided with, for example, a pair of diametrically opposed slits 234 within the lower end portion thereof, only one of which is visible, and an expansion rod or stud member which is adapted to be disposed internally of the external sleeve member 232. It is seen that the lower end portion 236 of the expansion rod or stud member has a substantially frusto-conical configuration, while the upper end portion of the rod or stud member is externally threaded as at 238, an annular shoulder portion 240 effectively being defined between the upper end portion of the external sleeve member 232 and the externally threaded end portion 238 of the expansion rod or stud member which projects upwardly out from the external sleeve member 232.

Continuing further, a jack support member 242 effectively comprises a hollow tubular unthreaded body portion or sleeve member 244 and a transversely extending head portion 246 such that the jack support member 242 effectively has a substantially T-shaped cross-sectional configuration. The hollow tubular unthreaded body portion or sleeve member 244 is adapted to be disposed over the upwardly projecting externally threaded end portion 238 of the rod or stud member such that the lower end portion of the hollow tubular unthreaded body portion or sleeve member 244 is disposed or seated upon the annular shoulder portion 240 of the anchor sleeve member 232 when the conventional prior art mechanical lock type anchor 230 is inserted into and disposed within the counterbored or undercut pre-drilled blind bore 204, while the transversely extending head portion 246 of the jack support member 242 will be engaged with or seated upon the upper surface portion 248 of the concrete structure or substrate 202, all as can best be appreciated from FIG. 10. In addition, an expansion stud extension 250 is also provided, and it is seen that the expansion stud extension 250 comprises a lower hollow internally threaded tubular portion 252 and an upper externally threaded rod portion 254.

Accordingly, as can also be appreciated from FIG. 10, after the conventional prior art mechanical lock type anchor 230 has been inserted into the undercut or counterbored pre-drilled blind bore 204, and after the jack support member 242 has also been effectively inserted into the upper portion of the undercut or counterbored pre-drilled blind bore 204 such that the lower end portion of the hollow tubular non-threaded body portion or sleeve member 244 is disposed or seated upon the annular shoulder portion 240 of the anchor sleeve member 232 while the transversely extending head portion 246 of the jack support member 242 is engaged with and seated upon the upper surface portion 248 of the concrete structure or substrate 202, then the expansion stud extension 250 is inserted downwardly into the hollow tubular unthreaded body portion or sleeve member 244 of the jack support member 242. The lower hollow internally threaded tubular portion 252 of the expansion stud extension 250 is adapted to be fully threadedly engaged with the upwardly projecting externally threaded end portion 238 of the rod or stud member of the anchor 230, and accordingly, the lower end face of the lower hollow internally threaded tubular portion 252 of the expansion stud extension 250 will likewise be seated upon the annular shoulder portion 240 of the anchor sleeve member 232. The externally threaded rod portion 254 of the expansion stud extension 250 now projects upwardly above the upper surface portion 248 of the concrete structure or substrate 202 and is ready to be engaged by means of a suitable jacking device or assembly, which is illustrated within FIG. 11 at 256, for in fact effectuating the mechanical locking or fixation of the conventional prior art mechanical lock type anchor 230 within the concrete structure or substrate 202.

More particularly, the jacking device or assembly 256 is seen to comprise a framework 258 which is effectively inserted over the upwardly projecting externally threaded rod portion 254 of the expansion stud extension 250 such that the upwardly projecting externally threaded rod portion 254 of the expansion stud extension 250 extends along an axially central locus of the jacking device or assembly 256. In addition, a lower cross-beam member 260 of the framework 258 is seated upon the transversely extending head portion 246 of the jack support member 242, while the lower end portion of an internally threaded coupling member 262 is threadedly engaged upon the upper end portion of the upwardly projecting externally threaded rod portion 254 of the expansion stud extension 250. Still further, an externally threaded jacking rod member 264 has its lower end portion threadedly engaged within the upper end portion of the internally threaded coupling member 262, while the upper end portion of the externally threaded jacking rod member 264 has a torquing nut 266 threadedly engaged thereon.

It can therefore be readily appreciated that as the torquing nut 266 is continuously rotated so as to be progressively threaded onto the upper end portion of the externally threaded jacking rod member 264, the expansion rod or stud member, through means of the various threaded connections defined between, for example, the externally threaded upper end portion 238 of the expansion rod or stud member and the internally threaded lower end portion 252 of the expansion stud extension 250, between the externally threaded upper end portion 254 of the expansion stud extension 250 and the lower end portion of the internally threaded coupling member 262, and between the upper end portion of the internally threaded coupling member 262 and the lower end portion of the externally threaded jacking rod member 264, will be axially elevated within and with respect to the surrounding tubular sleeve member 232 of the anchor 230. In this manner, as can best be appreciated from FIG. 11, the frusto-conically shaped lower end portion 236 of the expansion rod or stud member will engage and interact with internal side wall members of the surrounding tubular sleeve member 232 in order to cause the same to be expanded radially outwardly, as permitted by means of the slit regions 234 of the tubular sleeve member 232, such that the lower end portions of the tubular sleeve member 232 will be radially expanded into the undercut or counterbored regions 228 of the undercut or counterbored pre-drilled bore 204 defined within the concrete structure or substrate 202 so as to thereby mechanically lock the conventional prior art mechanical lock type anchor 230 within the concrete structure or substrate 202.

With reference now being made to FIGS. 12 and 13, upon conclusion of the installation of the conventional prior art mechanical lock type anchor 230 within the concrete substrate or structure 202, as has been illustrated within FIG. 11, it can be seen from FIG. 12 that the jacking device or assembly 256, the expansion stud extension 250, and the jack support member 242 have all been removed, thereby leaving the conventional prior art mechanical lock type anchor 230 lockingly disposed within the concrete structure or substrate 202. More particularly, the upper externally threaded end portion 238, not visible, of the rod or stud member of the anchor 230 is disposed at a predetermined distance below the upper surface portion 248 of the concrete structure or substrate 202, and an internally threaded coupling member 268 has its lower end portion threadedly engaged with the upper externally threaded end portion 238 of the rod or stud member of the anchor 230 such that the upper end portion of the coupling member 268 is likewise disposed a predetermined distance beneath the upper surface portion 248 of the concrete structure or substrate 202. Lastly, as can best be appreciated from FIG. 13, an externally threaded anchor rod 270 has its lower end portion threadedly engaged within the upper end portion of the internally threaded coupling 268 such that the upper end portion of the anchor rod 270 projects substantially above the upper surface portion 248 of the concrete structure or substrate 202, and then an object to be fixedly secured to and upon the upper surface portion 248 of the concrete structure or substrate 202, such as, for example, a mounting bracket or the like 272, having a suitable aperture formed therein for permitting the upper end portion of the anchor rod 270 to effectively pass therethrough, is disposed over the upper end portion of the anchor rod 270 such that the mounting bracket or the like 272 is seated upon the upper surface portion 248 of the concrete structure or substrate 202. A suitable nut member 274 is lastly threadedly engaged onto the upwardly projecting upper end portion of the anchor rod 270 so that a flange portion 276 of the nut member 276 ultimately engages that portion of the mounting bracket or the like 272 which is seated upon the upper surface portion 248 of the concrete structure or substrate 202 so as to in fact fixedly secure the mounting bracket or the like 272 which is seated upon the upper surface portion 248 of the concrete structure or substrate 202. This completes the entire installation process for fixedly securing the mounting bracket or the like 272 which is seated upon the upper surface portion 248 of the concrete structure or substrate 202.

While the utilization of such a conventional prior art mechanical lock type anchor 230 has its obvious advantages in view of being mechanically locked into the concrete structure or substrate 202, it can also be readily appreciated that the installation procedure is relatively complex and quite time-consuming in view of the different operative steps and structural components required to perform such operative steps, as has been previously disclosed and described in connection with FIGS. 5-13. More particularly, the pre-drilled blind bore 204 must initially be undercut or counterbored within the concrete structure or substrate 202, the conventional prior art mechanical lock type anchor 230 must then be installed within the undercut or counterbored pre-drilled blind bore 204, the jacking device or assembly 256 must then be operatively connected to the anchor 230 in order to in fact lockingly set the anchor 230 within the counterbored or undercut pre-drilled blind bore 204, and then the jacking device or assembly 256 needs to be removed so as to permit the article or object, such as, for example, a mounting bracket or the like 272, to be fixedly secured to the concrete structure or substrate 202.

A need therefore exists in the art for a new and improved mechanical lock anchor for installation within a concrete structure or substrate wherein the mechanical lock anchor is relatively simple in structure, has a relatively small number of component parts, and is relatively quick and easy to install.

### SUMMARY OF THE INVENTION

The foregoing and other objectives are achieved in accordance with the teachings and principles of the present invention through the provision of a new and improved mechanical lock-type anchor which comprises a solid rod member wherein the lower end portion of the solid rod member is adapted to be disposed within the lower end portion of the pre-drilled blind bore, and wherein a powder-actuated mechanical lock assembly is effectively disposed or embedded within the lower end portion of the solid rod member. In accordance with the teachings and principles of a first embodiment of the present invention, the powder-actuted mechanical lock assembly comprises a powder-actuated charge and a plurality of pins which are forced radially outwardly, as a result of the actuation or detonation of the powder-actuated charge, so as to extend or project into side wall portions of the concrete substrate or structure, which partially define the pre-drilled blind bore, thereby mechanically locking the mechanical lock-type anchor within the concrete structure or substrate. In accordance with additional teachings and principles of the present invention, the powder-actuated charge is adapted to be electrically or mechanically actuated or detonated.

In accordance with the principles and teachings of a second embodiment of the present invention, in lieu of utilizing a plurality of pins as is characteristic of the first embodiment of the present invention, the lower end portion of the solid rod anchor is adapted to be deformed in a predetermined manner, as a result of the actuation or detonation of the powder-actuated charge, whereby radially outwardly extending or projecting portions of the deformed lower end portion of the solid rod anchor will effectively engage and extend into or penetrate side wall portions of the concrete structure or substrate which partially define the pre-drilled bore. As was the case with the first embodiment of the present invention, the powder-actuated charge, utilized to deform the lower end portion of the solid rod anchor, is adapted to be electrically or mechanically actuated or detonated.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIGS. 1-4 are schematic cross-sectional views illustrating the sequential procedural steps involved in connection with the installation of a first type of conventional, prior art friction-type anchor within a pre-drilled blind bore formed within a concrete structure or substrate;

FIGS. 5-13 are schematic cross-sectional views illustrating the sequential procedural steps involved in connection with the installation of a second type of conventional, prior art mechanical lock-type anchor within a pre-drilled blind bore formed within a concrete substrate or structure;

FIGS. 14-17 are schematic cross-sectional views illustrating the sequential procedural steps involved in connection with the installation of a first embodiment of a new and improved mechanical lock-type anchor, as has been constructed in accordance with the principles and teachings of the present invention, within a pre-drilled blind bore formed within a concrete structure or substrate;

FIG. 18 is a schematic cross-sectional view illustrating the disposition of a modified or alternative variation of the first embodiment of the new and improved mechanical lock-type anchor, as disclosed within FIG. 17, which has also been constructed in accordance with the principles and teachings of the present invention, within a pre-drilled blind bore formed within a concrete structure or substrate;

FIG. 19 is a schematic cross-sectional view illustrating the disposition of a second embodiment of a new and improved mechanical lock-type anchor, as has been constructed in accordance with the principles and teachings of the present invention, within a pre-drilled blind bore formed within a concrete structure or substrate; and

FIG. 20 is a schematic cross-sectional view illustrating the disposition of a modified or alternative variation of the second embodiment of the new and improved mechanical lock-type anchor, as disclosed within FIG. 19, which has also been constructed in accordance with the principles and teachings of the present invention, within a pre-drilled blind bore formed within a concrete structure or substrate.

### DETAILED DESCRIPTION OF THE PREFERRED EMBODIMENT

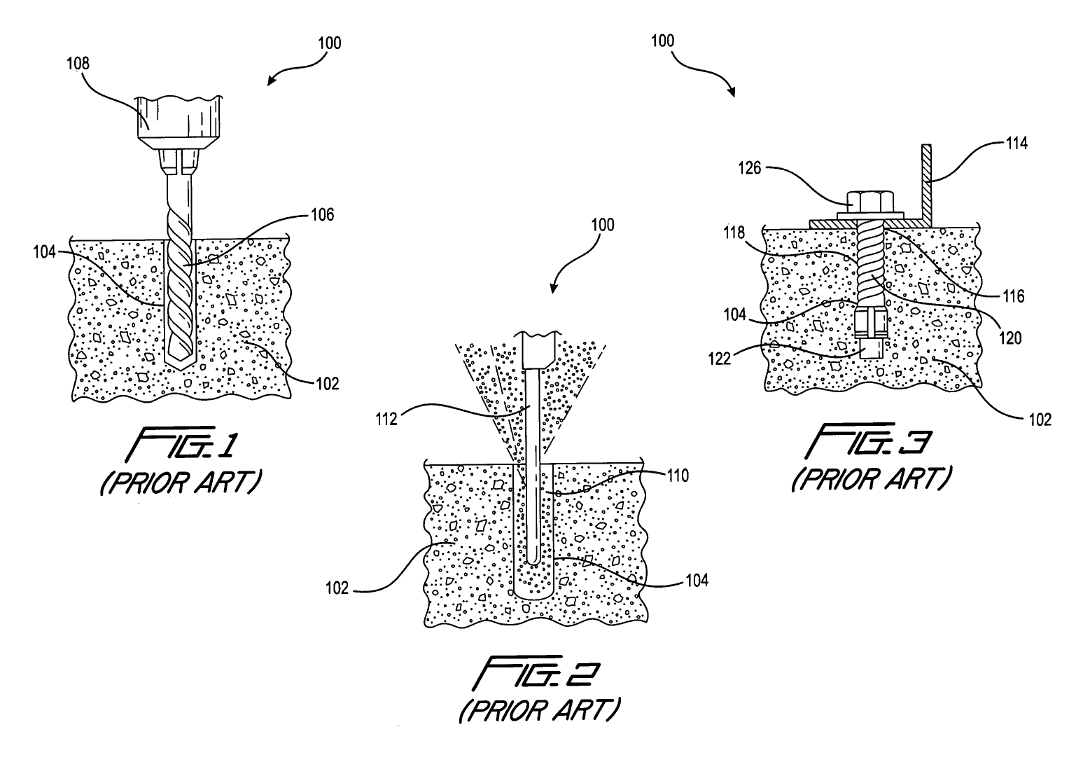

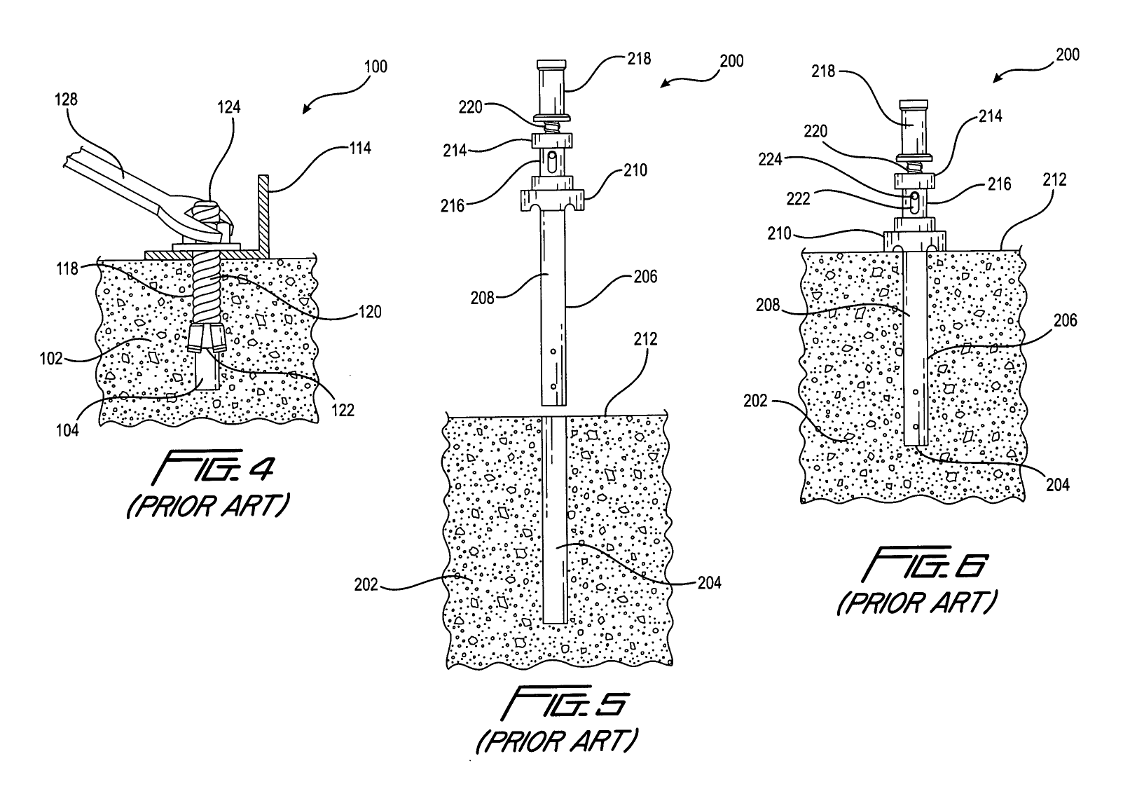

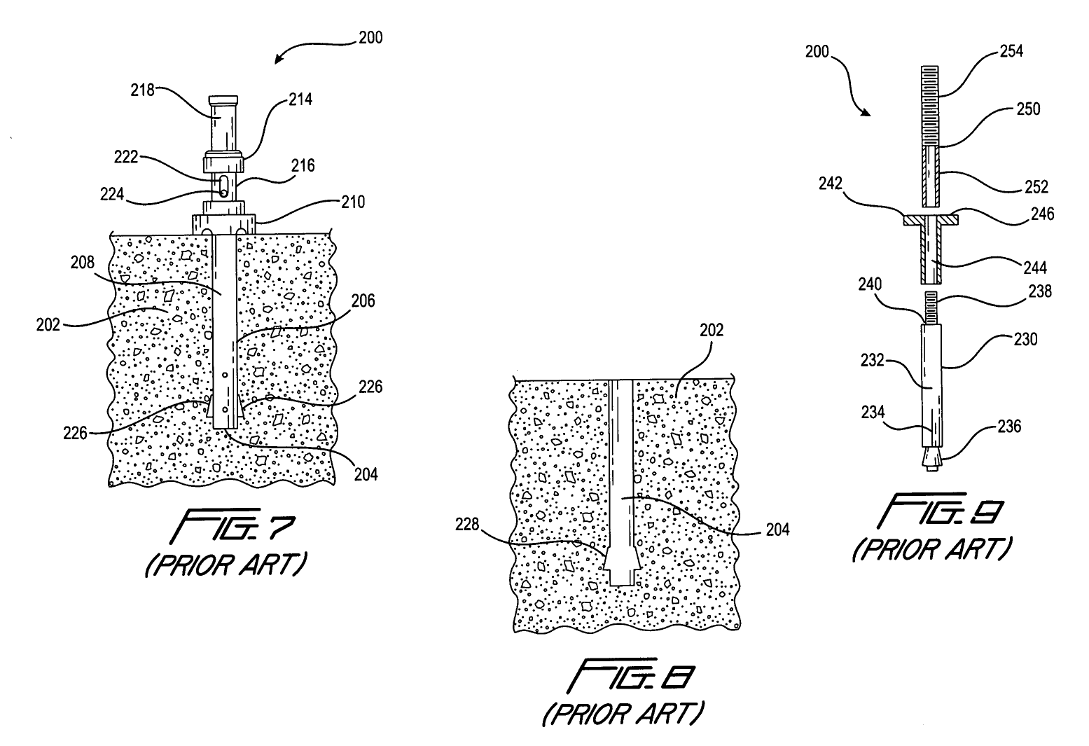

Referring now to the drawings, and more particularly to FIGS. 14-17 thereof, the sequential procedural steps involved in connection with the installation of a first embodiment of a new and improved mechanical lock-type anchor within a pre-drilled blind bore formed within a concrete substrate or structure, wherein the first embodiment of the new and improved mechanical lock-type anchor is generally indicated by the reference character 300 and has been constructed in accordance with the principles and teachings of the present invention, will now be described. It is to be understand that, for the purposes of this disclosure and description, the component parts of the first embodiment of the new and improved mechanical lock-type anchor system disclosed within FIGS. 14-17, which effectively correspond to the components parts of the previously described anchor systems disclosed within FIGS. 1-13, will be designated by corresponding reference characters, where possible, except that they will be within the 300 series. More particularly, it is seen that in accordance with the installation procedure for installing the first embodiment of the new and improved mechanical lock-type anchor 300 within a concrete structure or substrate 302, a blind bore 304 is initially drilled into the concrete structure or substrate 302 by means of a suitable drill bit 306 as illustrated within FIG. 14. As a result of the drilling operation, debris 308 from the surrounding concrete structure or substrate 302 accumulates within the drilled blind bore 304, however, in accordance with the principles and teachings of the present invention, the debris 308 does not need to be removed or cleaned out from the pre-drilled blind bore 304.

Accordingly, the drill bit 306 is removed from the pre-drilled blind bore 304, and the first embodiment of the new and improved mechanical lock-type anchor 300, as has been constructed in accordance with the principles and teachings of the present invention, is inserted downwardly into the pre-drilled blind bore 304 defined within the concrete structure or substrate 302. More particularly, in accordance with the principles and teachings of the present invention, the first embodiment of the new and improved mechanical lock-type anchor 300 is seen to comprise a solid rod member 310 and a powder-actuated mechanical locking assembly 312 effectively disposed or embedded within the lower end portion of the solid rod member 310. In turn, as can best be appreciated from FIGS. 16 and 17, the powder-actuated mechanical locking assembly 312 comprises a housing 314 within which there is disposed a powder-actuated charge and a plurality of mechanical locking pins which are disclosed at 316 in their radially outwardly extending or projected state.

In accordance with this first embodiment of the mechanical lock-type anchor 300, the solid rod member 310 is adapted to be electrically connected to a suitable source of electrical power PS. Accordingly, when the power source PS is activated, an electrical charge is electrically conducted downwardly into the solid rod member 310 so as to effectively actuate or detonate the powder-actuated charge disposed within the housing 314 whereupon the mechanical locking pins 316 will be forced outwardly in radial directions so as to engage and penetrate side wall portions of the concrete structure or substrate 302 which partially define the pre-drilled blind bore 304. The mechanical lock-type anchor 300 is now fixedly secured or locked within the concrete structure or substrate 302. It is of course to be appreciated that the concrete substrate or structure 302 is, or will be, properly electrically grounded, so as to in fact permit the powder-actuated charge disposed within the housing 314 to in fact be actuated or detonated, particularly in view of the fact that such concrete structures or substrates normally have rebar materials incorporated therewithin.

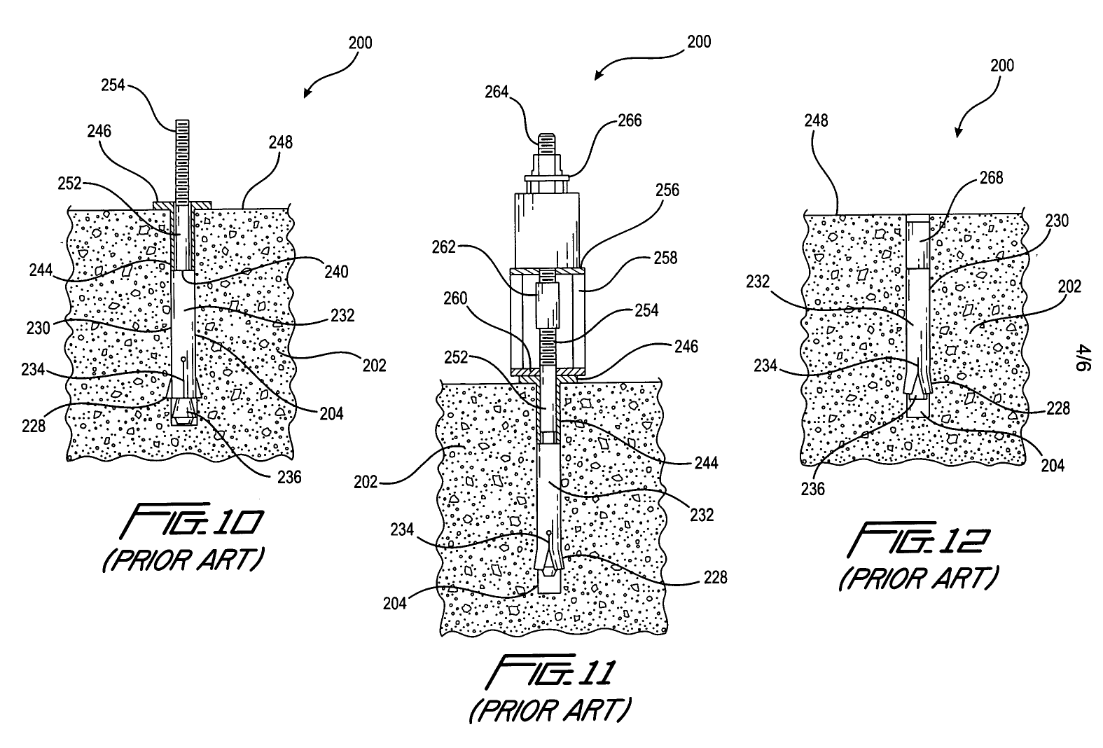

With reference now being made to FIG. 18, a modified or alternative variation of the first embodiment of the new and improved mechanical lock-type anchor 300 as disclosed within FIG. 17, which has also been constructed in accordance with the principles and teachings of the present invention for achieving a mechanically locked disposition within a pre-drilled blind bore formed within a concrete structure or substrate, is disclosed and will now be described. In view of the basic structural similarities that are characteristic of both the first embodiment of the new and improved mechanical lock-type anchor 300 and the modified or alternative variation of the first embodiment of the new and improved mechanical lock type anchor 300, only the differences between such embodiments will be discussed for brevity purposes. In addition, component parts of the modified or alternative variation embodiment of the new and improved mechanical lock-type anchor, which correspond to the component parts of the new and improved mechanical lock-type anchor 300, will be designated by corresponding reference characters except that they will be denoted by means of a prime (′). As a result of reference being made to FIG. 18, and comparing the same to FIG. 17, it is appreciated that in accordance with the principles and teachings of the modified or alternative variation embodiment of the new and improved mechanical lock-type anchor 300′, the modified or alternative variation embodiment of the new and improved mechanical lock-type anchor 300′ is not adapted to be electrically actuated as was the case with the first embodiment of the new and improved mechanical lock-type anchor 300 as disclosed within FIG. 17, but to the contrary, the modified or alternative variation embodiment of the new and improved mechanical lock-type anchor 300′ is adapted to be mechanically actuated.

Accordingly, a firing pin 318′ has been movably mounted within the lowermost end portion of the solid rod member 310′ such that the lower end portion of the firing pin 318′ is effectively engaged or disposed in contact with the bottom end wall portion of the blind bore 304. Therefore, when a mechanical force F is suitably applied to or impressed upon the upper end portion of the solid rod member 310′, by any suitable means 320′, which can comprise a manual means, an impacting machine, or the like, the firing pin 318′ will effectively be forced upwardly within the lower end portion of the solid rod member 310′, as a result of its reaction force against the bottom end wall portion of the blind bore 304, and will impact against the housing 314′ so as to actuate or cause detonation of the powder-actuated charge disposed internally within the housing 314′. As was the case with the first embodiment of the new and improved mechanical lock-type anchor 300, the mechanical locking pins 316′ will then be forced radially outwardly so as to engage and penetrate the side wall portions of the concrete structure or substrate 302 which partially define the pre-drilled blind bore 304 whereby the mechanical lock-type anchor 300′ is now fixedly secured or locked within the concrete structure or substrate 302.

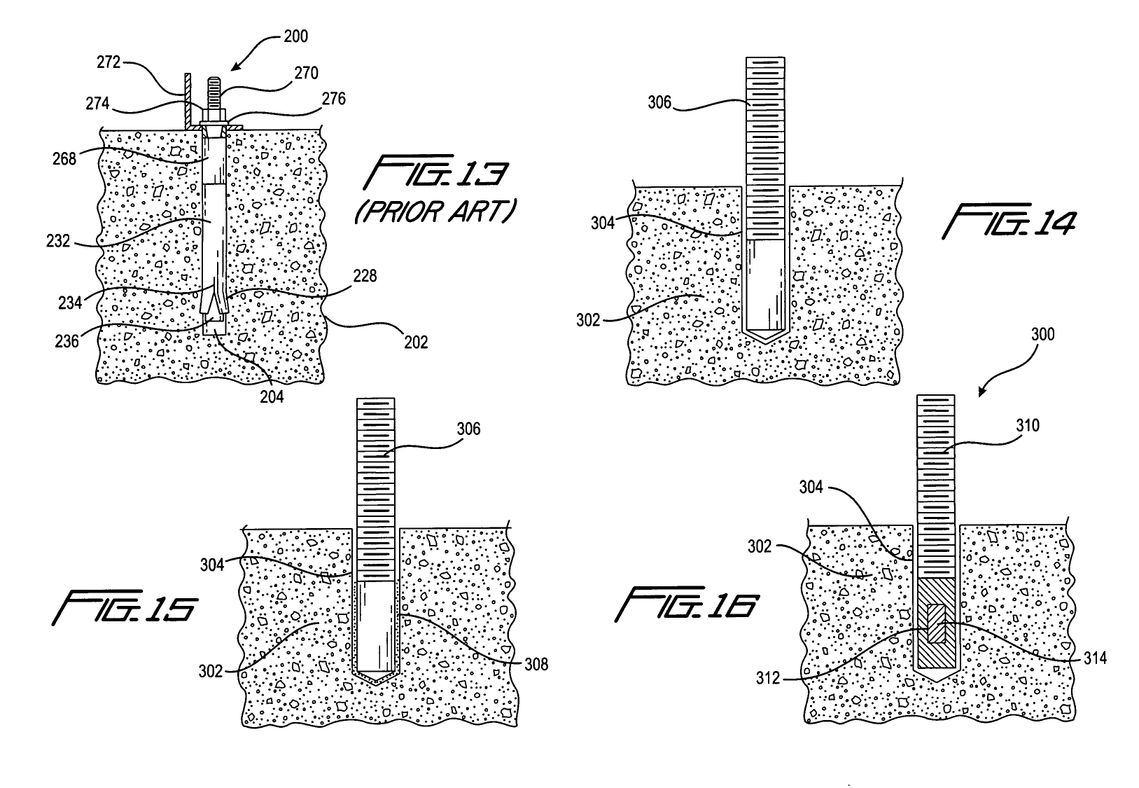

With reference now being made to FIG. 19, a second embodiment of a new and improved mechanical lock-type anchor, as constructed in accordance with the principles and teachings of the present invention for likewise achieving a mechanically locked disposition within a pre-drilled blind bore formed within a concrete structure or substrate, is disclosed and is generally indicated by the reference character 400. In view of the basic structural similarities that are characteristic of both the first and second embodiments of the new and improved mechanical lock-type anchors 300,400 as respectively disclosed within FIGS. 17 and 19, only the differences between such embodiments 300,400 will be discussed for brevity purposes. In addition, component parts of the second embodiment of the new and improved mechanical lock-type anchor 400 of the present invention, which correspond to the component parts of the first embodiment of the new and improved mechanical lock-type anchor 300, will be designated by corresponding reference characters except that they will be within the 400 series. More particularly, it is seen that, in lieu of the utilization of the explosively actuated, radially outwardly projecting mechanical locking pins 316 as operatively associated with and incorporated within the lower end portion of the solid rod member 310 of the first embodiment of the new and improved mechanical lock-type anchor 300, the lower end portion of the solid rod member 410 of the second mechanical lock-type anchor 400 is prefabricated in such a manner, such as, for example, by effectively having predeterminedly designed weakened side wall portions integrally incorporated therein, characterized by predeterminedly designed and located slits or the like, not actually shown, that when the powder-actuated charge, disposed within the housing 414, is in fact activated or detonated, the prefabricated, predeterminedly designed weakened side wall portions of the lower end portion of the solid rod member 410 will be explosively deformed in a radially outward manner. Accordingly, barbed or pointed projections 416 will be forced radially outwardly from, or with respect to, the lower end portion of the solid rod member 410 so as to engage and penetrate side wall portions of the concrete structure or substrate 402 that partially define the pre-drilled blind bore 404. In this manner, the second embodiment mechanical lock-type anchor 400 will be fixedly secured and anchored within the concrete substrate or structure 402. As was the case with the first embodiment mechancial lock-type anchor 300, the powder-actuated charge disposed within the housing 414 may be electrically actuated by means of electrical power supplied thereto from a suitable power source PS.

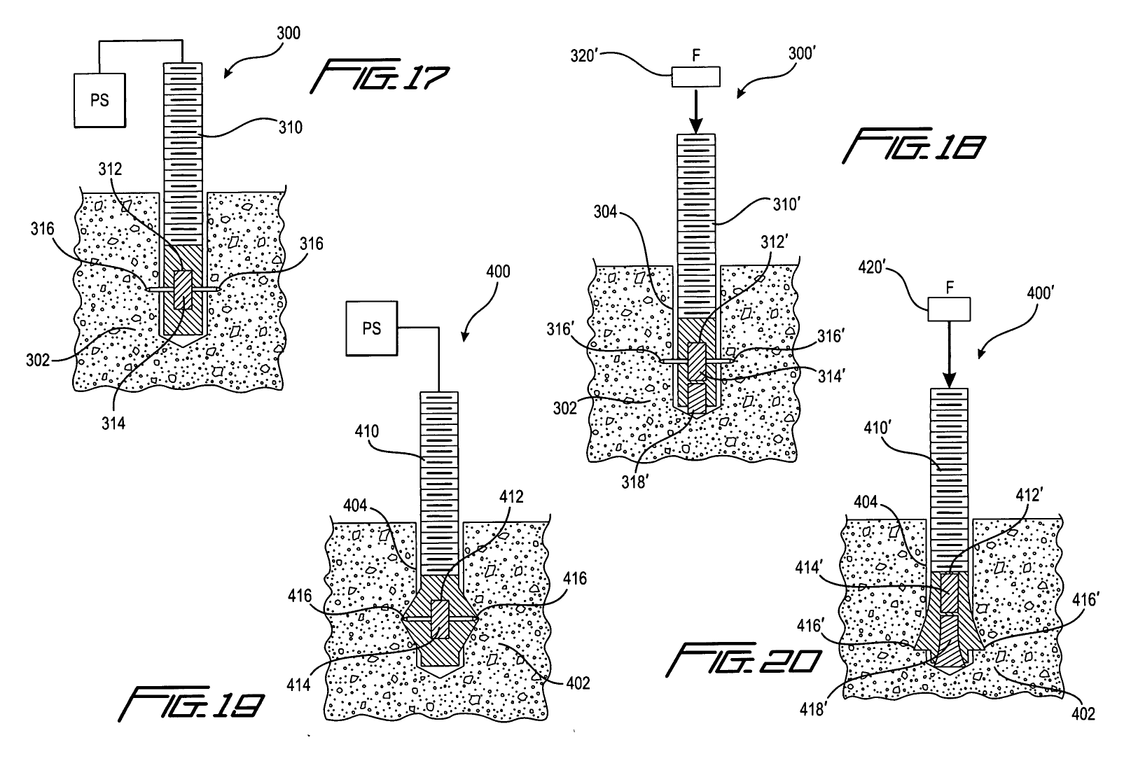

With reference lastly being made to FIG. 20, a modified or alternative variation of the second embodiment of the new and improved mechanical lock-type anchor 400 as disclosed within FIG. 19, which has also been constructed in accordance with the principles and teachings of the present invention for achieving a mechanically locked disposition within a pre-drilled blind bore formed within a concrete substrate or structure, is disclosed and will now be described.

In view of the basic structural similarities that are characteristic of both the second embodiment of the new and improved mechanical lock-type anchor 400 and the modified or alternative variation of the second embodiment of the new and improved mechanical lock type anchor 400, only the differences between such embodiments will be discussed for brevity purposes. In addition, component parts of the modified or alternative variation embodiment of the new and improved mechanical lock-type anchor, which correspond to the component parts of the new and improved second embodiment mechanical lock-type anchor 400, will be designated by corresponding reference characters except that they will be denoted by means of a prime (′).

As a result of reference being made to FIG. 20, and comparing the same to FIG. 19, as well as comparing the same to the first modified or alternative variation embodiment 300′ as disclosed within FIG. 18, it is appreciated that in accordance with the principles and teachings of the second modified or alternative variation embodiment of the new and improved mechanical lock-type anchor 400′, the second modified or alternative variation embodiment of the new and improved mechanical lock-type anchor 400′ is not adapted to be electrically actuated as was the case with the second embodiment of the new and improved mechanical lock-type anchor 400 as disclosed within FIG. 19, but to the contrary, the second modified or alternative variation embodiment of the new and improved mechanical lock-type anchor 400′ is adapted to be mechanically actuated. Accordingly, a firing pin 418′ has been movably mounted within the lowermost end portion of the solid rod member 410′ such that the lower end portion of the firing pin 418′ is effectively engaged or disposed in contact with the bottom end wall portion of the blind bore 404. Therefore, when a mechanical force F is suitably applied to or impressed upon the upper end portion of the solid rod member 410′, again, by any suitable means 420′, which can comprise a manual means, an impacting machine, or the like, the firing pin 418′ will effectively be forced upwardly within the lower end portion of the solid rod member 410′, as a result of its reaction force against the bottom end wall portion of the blind bore 404, and will impact against the housing 414′ so as to actuate or cause detonation of the powder-actuated charge disposed internally within the housing 414′. As was the case with the second embodiment of the new and improved mechanical lock-type anchor 400, the mechanical barbs or projections 416′ will then be forced radially outwardly so as to engage and penetrate the side wall portions of the concrete structure or substrate 402 which partially define the pre-drilled blind bore 404 whereby the mechanical lock-type anchor 400′ is now fixedly secured or locked within the concrete structure or substrate 402.

Thus, it may be seen that in accordance with the principles and teachings of the present invention, there has been disclosed various embodiments of a new and improved mechanical lock-type anchor for fixation within a concrete substrate or structure wherein as the result of the actuation or detonation of a powder-actuated charge, radially outwardly extending or projecting mechanical locking pins or barbed projections are effectively forced into contact with and penetrate side wall portions of the concrete substrate or structure which partially define a pre-drilled blind bore within which the mechanical lock-type anchor is disposed. In this manner, the mechanical locking pins or barbed projections fixedly secure or anchor the mechanical lock-type anchor within the concrete structure or substrate. The powder-actuated charge may be electrically or mechanically actuated or detonated so as to, in turn, effectively move the mechanical locking pins or barbed projections to their operative positions within the concrete structure or substrate, and it can be lastly appreciated that the new and improved mechanical lock-type anchor is relatively simple in structure, it comprises a relatively small number of component parts, and is relatively quick and easy to install within the concrete substrate or structure.

Obviously, many variations and modifications of the present invention are possible in light of the above teachings. For example, while the application has discussed, or used as an example, explosively actuated means, other expansive means may of course be utilized. Similarly, while the actuating means for the aforenoted explosively actuated or other expansive means have been exemplified by mechanical or electrical means, again, other actuating means may be employed. Lastly, while the locking means have been described as moving radially outwardly, the term “radially outwardly” is to be understood in its broadest sense and can effectively encompass outward movement in any one or multiple directions or orientations. It is therefore to be understood that within the scope of the appended claims, the present invention may be practiced otherwise than as specifically described herein.

What is claimed as new and desired to be protected by Letters Patent of the United States of America, is:

1. An expansively-actuated mechanical lock anchor to be lockingly engaged within a bore defined within a structure, comprising:
a solid rod anchor member defined around a longitudinally extending axis and adapted to be disposed within a bore pre-drilled within a structure into which said solid rod anchor member is to be fixedly secured;
a housing, containing an expansively-actuated means, disposed within a lower end portion of said solid rod anchor member;
mechanical locking means disposed upon said housing for moving outwardly from said housing and into engagement with side wall portions of the structure within which the pre-drilled bore is defined so as to lockingly engage said solid rod anchor member within the structure; and
means for actuating said expansively-actuated means disposed within said lower end portion of said solid rod anchor member so as to cause said mechanical locking means to be moved outwardly from said housing and into engagement with the side wall portions of the structure within which the pre-drilled bore is defined so as to lockingly engage said solid rod anchor member within the structure.

2. The mechanical lock anchor as set forth in claim 1, wherein:
said expansively-actuated substance disposed within said housing comprises an explosively-actuated substance.

3. The mechanical lock anchor as set forth in claim 2, wherein:
said explosively actuated substance comprises a powder-actuated charge.

4. The mechanical lock anchor as set forth in claim 1, wherein:
said means for actuating said expansively-actuated means comprises electrical means.

5. The mechanical lock anchor as set forth in claim 4, wherein:
said electrical means comprises an electrical power source electrically connected to said solid rod anchor member such that electricity can be electrically conducted within said solid rod anchor member from said electrical power source to said expansively-actuated means in order to cause said expansively-actuated means to expand and force said mechanical locking means to move outwardly and into engagement with the side wall portions of the structure within which the pre-drilled bore is defined so as to lockingly engage said solid rod anchor member within the structure.

6. The mechanical lock anchor as set forth in claim 1, wherein:
said mechanical locking means comprises at least one pair of radially outwardly extending oppositely disposed locking pins.

7. The mechanical lock anchor as set forth in claim 6, wherein:
said means for actuating said expansively-actuated means comprises electrical means.

8. The mechanical lock anchor as set forth in claim 7, wherein:
said electrical means comprises an electrical power source electrically connected to said solid rod anchor member such that electricity can be electrically conducted within said solid rod anchor member from said electrical power source to said expansively-actuated means in order to cause said expansively-actuated means to expand and force said at least one pair of radially outwardly extending oppositely disposed locking pins to move radially outwardly and into engagement with the side wall portions of the structure within which the pre-drilled bore is defined so as to lockingly engage said solid rod anchor member within the structure.

9. The mechanical lock anchor as set forth in claim 1, wherein:
said means for actuating said expansively-actuated means comprises mechanical means.

10. The mechanical lock anchor as set forth in claim 9, wherein said mechanical means comprises:
a firing pin movably disposed within said lower end portion of said solid rod anchor member; and
impact means operatively connected to an upper end portion of said solid rod anchor member for impressing an impact force onto said upper end portion of said solid rod anchor member so as to effectively cause said firing pin to reactively impact against said housing so as to thereby actuate said expansively actuated means disposed within said housing and force said mechanical locking means to move outwardly and into engagement with the side wall portions of the structure within which the pre-drilled bore is defined so as to lockingly engage said solid rod anchor member within the structure.

11. The mechanical lock anchor as set forth in claim 6, wherein:
said means for actuating said expansively-actuated means comprises mechanical means.

12. The mechanical lock anchor as set forth in claim 11, wherein said mechanical means comprises:
a firing pin movably disposed within said lower end portion of said solid rod anchor member; and
impact means operatively connected to an upper end portion of said solid rod anchor member for impressing an impact force onto said upper end portion of said solid rod anchor member so as to effectively cause said firing pin to reactively impact against said housing so as to thereby actuate said expansively actuated means disposed within said housing and force said at least one pair of radially outwardly extending oppositely disposed locking pins to move radially outwardly and into engagement with the side wall portions of the structure within which the pre-drilled bore is defined so as to lockingly engage said solid rod anchor member within the structure.

13. The mechanical lock anchor as set forth in claim 1, wherein:
said mechanical locking means comprises at least one pair of radially outwardly extending oppositely disposed locking barbs comprising deformed portions of said lower end portion of said solid rod anchor member.

14. The mechanical lock anchor as set forth in claim 13, wherein:
said means for actuating said expansively-actuated means comprises electrical means.

15. The mechanical lock anchor as set forth in claim 14, wherein:
said electrical means comprises an electrical power source electrically connected to said solid rod anchor member such that electricity can be electrically conducted within said solid rod anchor member from said electrical power source to said expansively-actuated means in order to cause said expansively-actuated substance to expand and force said at least one pair of radially outwardly extending oppositely disposed locking barbs to move radially outwardly and into engagement with the side wall portions of the structure within which the pre-drilled bore is defined, as a result of said deformation of said lower end portion of said solid rod anchor member, so as to lockingly engage said solid rod anchor member within the structure.

16. The mechanical lock anchor as set forth in claim 13, wherein:
said means for actuating said expansively-actuated means comprises mechanical means.

17. The mechanical lock anchor as set forth in claim 16, wherein said mechanical means comprises:
a firing pin movably disposed within said lower end portion of said solid rod anchor member; and
impact means operatively connected to an upper end portion of said solid rod anchor member for impressing an impact force onto said upper end portion of said solid rod anchor member so as to effectively cause said firing pin to reactively impact against said housing so as to thereby actuate said expansively actuated substance disposed within said housing and thereby force said at least one pair of radially outwardly extending oppositely disposed locking barbs to move radially outwardly and into engagement with the side wall portions of the structure within which the pre-drilled bore is defined, as a result of said deformation of said lower end portion of said solid rod anchor member, so as to lockingly engage said solid rod anchor member within the structure.
